(19) United States
(12) Patent Application Publication
(10) Pub. No.: US 2011/0070421 A1
(43) Pub. Date: Mar. 24, 2011

(54) NON-WETTABLE SURFACES

(75) Inventors: Zdenek Cerman, Eppstein (DE); Boris F. Striffler, Zulpich-Nemmenich (DE); Sabine Wiersch, Bonn (DE); Wilhelm Barthlott, Bonn (DE)

(73) Assignee: Rheinische Friedrich-Wilhelms-Universitat Bonn, Bonn (DE)

(21) Appl. No.: 12/865,584

(22) PCT Filed: Jan. 30, 2009
(86) PCT No.: PCT/EP09/51044

§ 371 Date: Dec. 1, 2010

(30) Foreign Application Priority Data
Feb. 1, 2008 (DE) 10 2008 007 426.8

(51) Int. Cl. B32B 5/00

(52) U.S. Cl. 428/292.1

(57) ABSTRACT

An object having a surface that has:
filaments having a length of from 30 to 6000 μm, a diameter to length ratio of from 1:10 to 1:20, and are bound to the surface with at least one front face thereof;
wherein the distance between two neighboring filaments on the surface is such that the ratio of such distance to the length of the filaments is from 1:3 to 1:10;
the filaments have an elasticity of from 10⁴ to 10¹⁰ N/m²;
the surface of the filament is at least partially hydrophobic, so that the contact angle between a filament and water is greater than 100°,
   characterized in that the filaments are structurally or chemically anisotropic.

The present invention relates to non-wettable surfaces, processes for the preparation thereof, and the use thereof.

WO 96/04123 relates to self-cleaning surfaces of objects having elevations of hydrophobized material. Contaminations deposited on such surfaces can be removed by moving water.

Such surfaces are interesting in fields of application where surfaces are in contact with contaminations, for example, from the air, and can be cleaned by occasional contact with water, for example, rain. As found in studies, such surfaces have contact angles with water of above 130°. The drops, which adopt a spherical shape, are not capable of wetting the surface.

US 2005/0061221 describes the problem of reducing the frictional resistance in a relative motion between a solid surface and a liquid. A hierarchic fractal structure is described for that purpose. Examples are not described.

WO 2005/005679 relates to nanofibers and structures comprising nanofibers, and the use thereof.

WO 2007/099141 relates to non-wettable surfaces in which the surfaces have filaments.

It has been found that although the corresponding surfaces are non-wettable, they still fail to show optimum non-wettability, especially for long-term applications or for applications in fast-flowing bodies of water.

Surprisingly, it has been found that structures showing excellent non-wettability in air upon contact with water are not able to maintain such non-wettability permanently in an immersed state.

Thus, there remains a desire for surfaces that are non-wettable by water, i.e., are not wet after being contacted with water. Such surfaces are able to reduce the frictional resistance between water and the surface and also have other properties that are desirable from a technological point of view, such as thermal insulation or avoiding of biofouling.

It is the object of the invention to provide such surfaces.

This object is achieved by an object having a surface with the following characteristics:
filaments having a length of from 30 to 6000 μm, a diameter to length ratio of from 1:10 to 1:20 that are bound to the surface with at least one front face thereof;
wherein the distance between two neighboring filaments on the surface is such that the ratio of such distance to the length of the filaments is from 1:3 to 1:10;
the filaments have an elasticity of from 10⁴ to 10¹⁰ N/m²;
the surface of the filaments is at least partially hydrophobic, so that the contact angle between a filament and water is greater than 100°, the filaments being structurally or chemically anisotropic.

Thus, according to the invention, an object having a surface is provided. Thus, the structures according to the invention can have regions that are chemically anisotropic, in particular, in which the surface properties have the result that only parts of the filaments are hydrophobic while others are hydrophilic.

“Hydrophilic” means that the contact angle between the surface and water in these regions is <90°.

In another embodiment, a subregion of the structure is provided with an electric charge. Electrostatic charging promotes non-wettability.

In other embodiments, the filament is structurally anisotropic, i.e., there are regions in which the filaments have incisions, in particular, in which they form indentations.

In a particularly preferred embodiments, the filaments are provided with both chemically anisotropic regions and structurally anisotropic regions.

A filament within the meaning of the present application is any elongate structure made of any material that has the required properties. In the textile field, a distinction is made between protruding hairs, protruding fibers and filaments, which have a very great length. Within the meaning of the present application, however, the term “filament” is used for any kind of structure that has ends. Its length and diameter can be seen from the further definition in the claims. For this application, the word “filament” is interchangeable with the terms “fiber” or “hair” as used in the textile field. A filament within the meaning of the present application is also a lengthy structure bound to a surface at two or more points. In this case, the region between two contact points defines the length of the filament within the meaning of the present application.

When a filament as understood by the textile industry, i.e., structures consisting of long fibers whose length is limited only by the winding capacity of a bobbin, is referred to in this application text, the term “textile filament” is used. Such textile filaments have a length of many meters.

At the surface according to the invention, there are filaments having a length that is greater than their diameter. The diameter to length ratio (diameter:length) is from 1:10 to 1:20, preferably from 1:12 to 1:18. Suitable lengths are within a range of from 30 to 6000 μm, preferably from 50 to 1000 μm, more preferably from 50 to 200 μm, as well as from 1000 to 3000 μm.

If structures are bound to the surface at several contact points, they also form filaments having a corresponding length if the appropriate distances exist between two contact points, i.e., the length of the structures between two contact points is measured; this length is defined as the length of the filament.

The filaments have two front faces situated at either end of the filaments.

In one embodiment, exactly one front face is bound to the surface. In another embodiment, both front faces are bound, so that the filament forms a loop on the surface. Mixed forms in which both filaments bound with one front face and filaments bound with two front faces occur are also possible.

The diameters of filaments can be measured, for example, by scanning electron microscopy.

If the fibers have diameters that vary over the length of the fiber, the diameter in the middle of the filament (at 50% of the length) is used.

The filaments are on the surface in a mutual distance, wherein the ratio of the distance to the length of neighboring filaments (distance:length) is from 1:3 to 1:10, i.e., for a filament having a length of 6000 μm, a neighboring filament is at a distance within a range of from 2000 to 600 μm.

In one embodiment, the ratio may also be within a range of from 1:3 to 1:30.

The elasticity of the filaments is important to the surface according to the invention. The elasticity as determined by the modulus of elasticity is within a range of from 10⁴ to 10¹⁰ N/m². The elasticity allows an elastic elongation of the filaments. A preferred range is from 10⁶ to 10⁸ N/m². Preferably, the flexural modulus of elasticity is also within this range.

Further, the surface of the filament must be at least partially hydrophobic, so that the contact angle between a filament and water is greater than 100°. This can be measured, for example, with an inverted microscope and ultrasonic atomization as described in Suter et al., Journal of Arachnology, 32 (2004), pages 11 to 21. Preferably, the contact angle is greater than 110°.

In another embodiment, the hydrophobicity can also be measured macroscopically. Materials according to the invention preferably have macroscopic contact angles of greater than 140°.

Surprisingly, such surfaces according to the invention are able to entrap air within the structures in a way that it is not displaced by water; thus, the surfaces are non-wettable. In particular, the elasticity of the filaments is important, since this allows to retain the air even in currents. Movements of the water can be absorbed elastically by the filaments.

In one embodiment, the filament itself has a structure comprising elevations with a height of from 20 nanometers to 10 μm. Preferably, the elevations are smaller than 10% of the diameter of the filament.

Preferred embodiments of the present invention are not wetted upon contacting with water. “Not wetted” means that when the surface is completely submerged in water at a depth of 15 cm for 48 hours, at least 97% of the surface is found to be dry in a macroscopic test upon emerging of the object.

The invention also relates to a process for preparing such objects, comprising the steps of:

preparing a surface with the filaments in such a way that:
it has filaments having a length of from 30 to 6000 μm, a diameter to length ratio of from 1:10 to 1:20, and are bound to the surface with at least one front face thereof;
wherein the distance between two neighboring filaments on the surface is such that the ratio of such distance to the length of the filaments is from 1:3 to 1:10;
the filaments have an elasticity of from 10⁴ to 10¹⁰ N/m²;
the surface of the filament is at least partially hydrophobic, so that the contact angle between a filament and water is greater than 100°.

The structures according to the invention are capable of permanently maintaining air layers on their surface when under water. Thus, one or more of the following properties can be achieved:
reduction of friction;
prevention of corrosion, especially biofouling;
thermal insulation.

Interesting applications are applications in which structures are permanently immersed in liquids or water, for example, bodies of ships and boats, pipelines etc.

A possibility of preparing such structures are so-called micro-replica processes. In such processes, the surface of a material that has appropriate properties is converted to a negative by means of a casting compound. This negative form may then be used to prepare corresponding surfaces by means of a liquid plastic material, for example, a synthetic resin lacquer.

In a particular preferred embodiment, several such forms are used in order that surfaces with greater surface areas can be obtained.

A process in which the negative forms are assembled to a roll is particularly suitable. In this way, the preparation may be effected continuously by passing a curable plastic composition through the roll nip. Directly after the forming, the synthetic resin composition is cured by irradiation, for example, ultraviolet irradiation, and then remains in the surface structure as defined by the form.

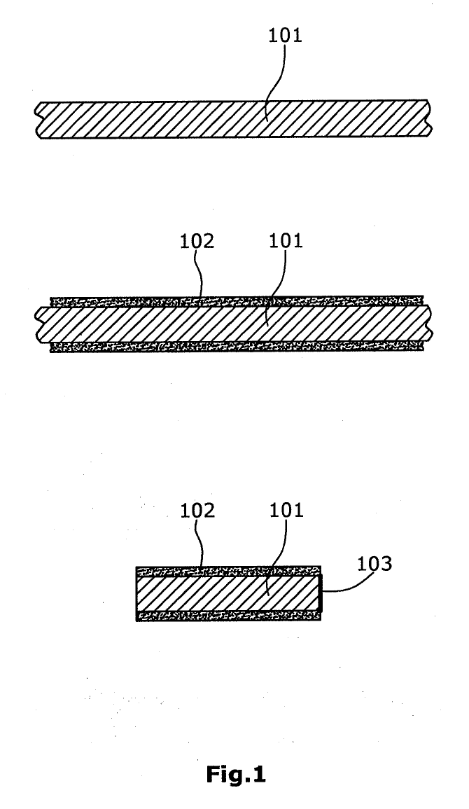

FIGS. 1 to 5 schematically show different ways to obtain the structures according to the invention.

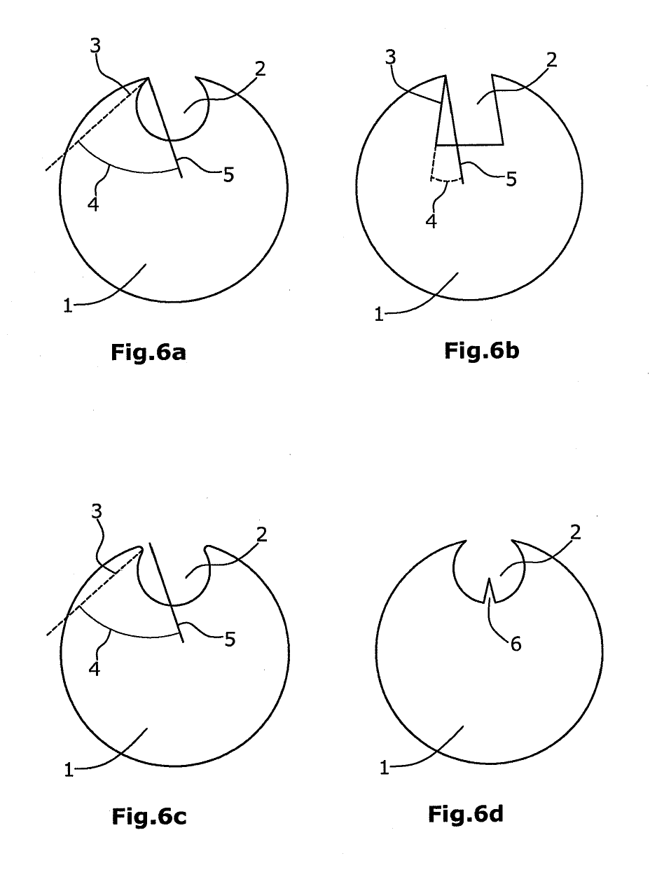

FIGS. 6a to d show different cross-sections of the filaments according to the invention and show the possibilities of incisions, especially indentations.

The invention is further illustrated by the following Examples.

### EXAMPLE 1

As shown in FIG. 1, a hydrophilic fiber 101 is hydrophobized with suitable means 102 in a first process step. Subsequently, this fiber is chopped for flocking, the segments having a uniform length within a range of from 30 to 6000 μm. The chopped fiber is employed for flocking. The apical end 103 of the fiber is not hydrophobic due to the chopping.

### EXAMPLE 2

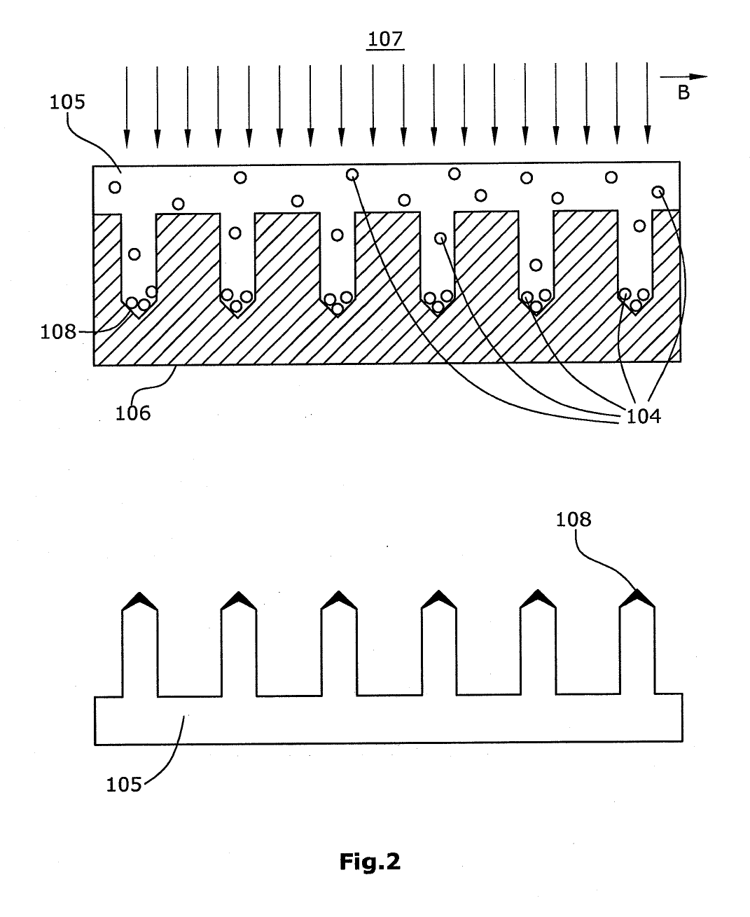

As shown in FIG. 2, a plastic material 105 admixed with a hydrophilic metal compound 104 (for example, metal hydr(oxides) of silicon, aluminum, magnesium) is into a negative form 106 of the surface. By using a magnetic field 107 at the hydrophilic regions, which will later be facing the water, the metals will be selectively deposited there and form the hydrophilic regions 108 of the desired surface in an otherwise hydrophobic plastic material.

### EXAMPLE 3

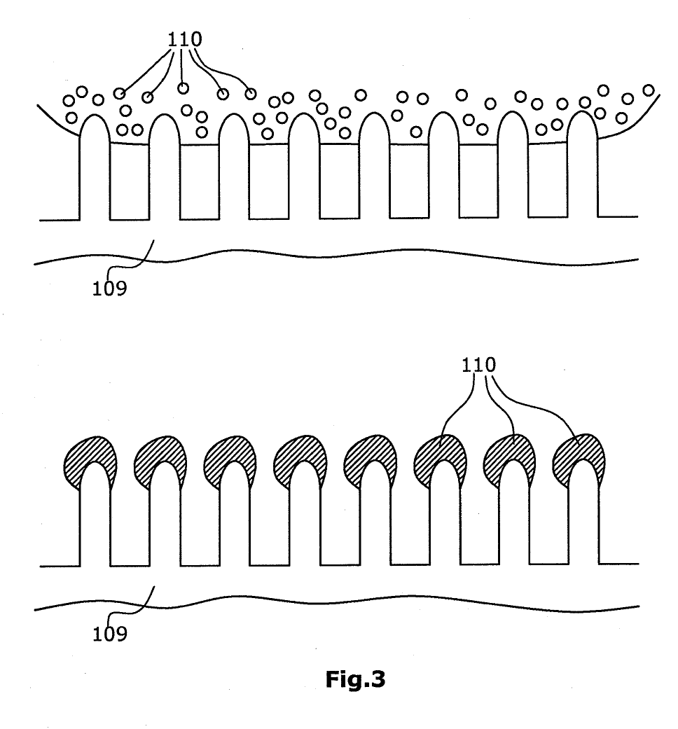

As shown in FIG. 3, a hydrophobic surface 109, for example, a fiber-coated one, is immersed in water or coated with water. In the water, there is a hydrophilic powder 110, which is preferably deposited on the tips of the structures. This effect is enhanced when the water dries out at the surface. Alternatively, the surface is immersed in a non-wetting liquid. Acids or lyes or electrodeposition liquids may serve as the liquid. Etching or electrodeposition may cause a chemical or structural change locally at the contact sites.

In another embodiment, a chemical component that induces a structure by self-organization, for example, nanotubes, nanorods etc., is deposited at the wetted portions upon immersion.

### EXAMPLE 4

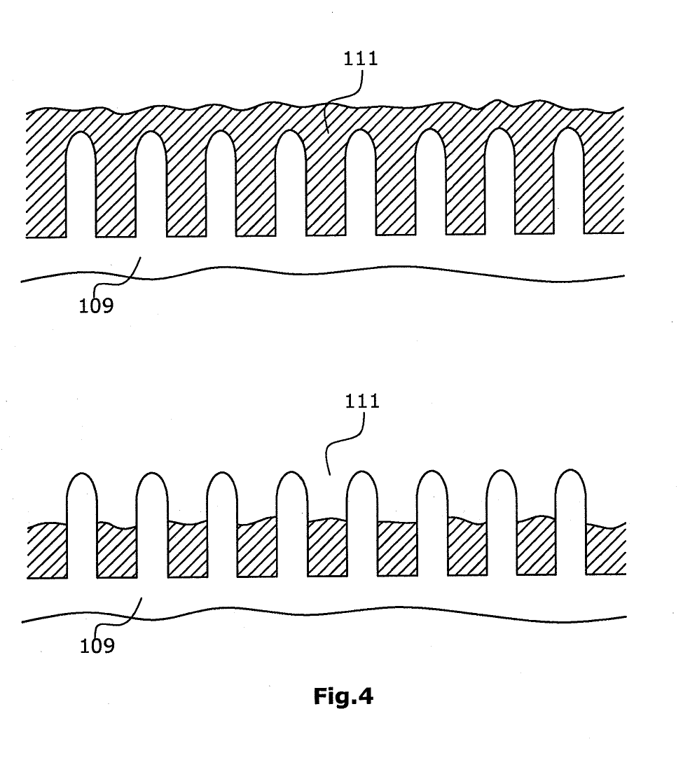

As shown in FIG. 4, a structure 109 is soaked with an oil 111 that evaporates at low temperatures. Heating causes the oil the evaporate gradually so that the tips of the structures become visible. These tips are hydrophilized by using plasma or the like.

### EXAMPLE 5

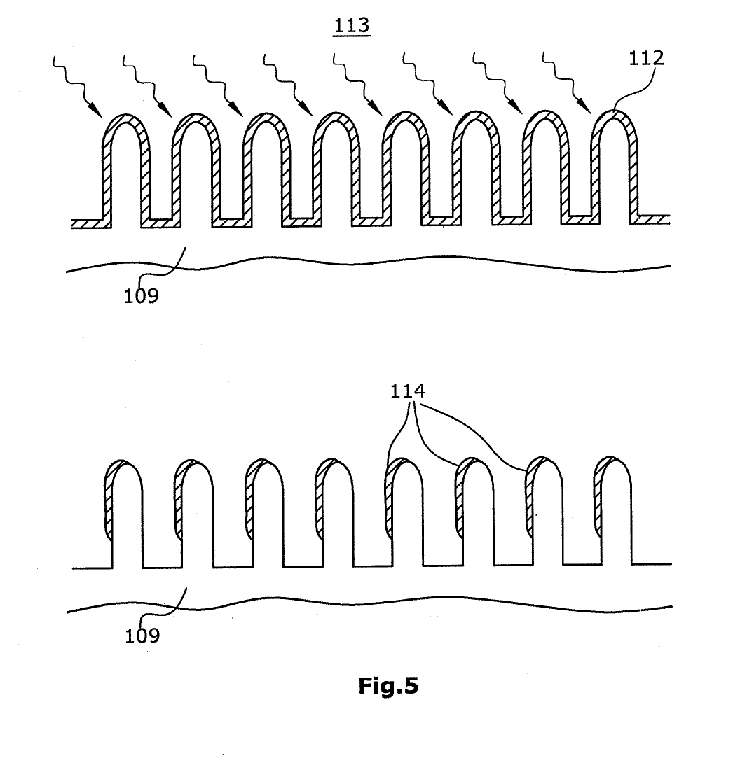

As shown in FIG. 5, the tips of structure 109 are coated with a photosensitive lacquer 112. The entire surface is exposed to obliquely incident light 113. In this way, only particular sites of the surface are “developed” exclusively. Hydrophobicity or structure is achieved only at these sites 114 by etching or coating with substances specifically binding to such sites (for example, by CVD or PVD).

### EXAMPLE 6

Another embodiment is the use of indented electrostatically chargeable microfibers as flocking agents.

1. An object having a surface that has:
filaments having a length of from 30 to 6000 μm, a diameter to length ratio of from 1:10 to 1:20, and are bound to the surface with at least one front face thereof;
wherein the distance between two neighboring filaments on the surface is such that the ratio of such distance to the length of the filaments is from 1:3 to 1:10;
the filaments have an elasticity of from 10⁴ to 10¹⁰ N/m²;
the surface of the filament is at least partially hydrophobic, so that the contact angle between a filament and water is greater than 100°,
wherein the filaments are structurally or chemically anisotropic.

2. (canceled)

3. The object according to claim 1, wherein said filaments have at least one region that is hydrophilic, so that the contact angle between this region and water is <90°.

4. The object according to claim 1, wherein said filaments have incisions in a longitudinal direction.

5. The object according to claim 3, wherein said incisions form indentations.

6. The object according to claim 1, wherein said filament is provided with a structure comprising elevations with a height of from 20 nanometers to 10 μm.

7. The object according to claim 1, wherein said filaments are bound to the surface with both front faces thereof.

8. The object according to claim 1, wherein said filaments have at least one region that is electrostatically charged.

9. (canceled)

10. A surface comprising:
filaments having a length of from 30 to 6000 μm, a diameter to length ratio of from 1:10 to 1:20, and are bound to the surface with at least one front face thereof;
wherein the distance between two neighboring filaments on the surface is such that the ratio of such distance to the length of the filaments is from 1:3 to 1:10;
the filaments have an elasticity of from 10⁴ to 10¹⁰ N/m²;
the surface of the filament is at least partially hydrophobic, so that the contact angle between a filament and water is greater than 100°,
wherein the filaments are structurally or chemically anisotropic.

11. The surface according to claim 10, wherein said filaments have at least one region that is hydrophilic, so that the contact angle between this region and water is <90°.

12. The surface according to claim 11, wherein said filaments have incisions in a longitudinal direction.

13. The surface according to claim 12, wherein said incisions form indentations.

14. The surface according to claim 10, wherein said filament is provided with a structure comprising elevations with a height of from 20 nanometers to 10 μm.

15. The surface according to claim 10, wherein said filaments are bound to the surface with both front faces thereof.

16. The surface according to claim 10, wherein said filaments have at least one region that is electrostatically charged.

17. A method of for achieving non-wettability, said method comprising providing or applying a surface according to claim 10 on an object.
